(19) United States
(12) Patent Application Publication
(10) Pub. No.: US 2021/0333747 A1
(43) Pub. Date: Oct. 28, 2021

(54) IMAGE FORMING APPARATUS

(71) Applicant: Konica Minolta, Inc., Tokyo (JP)

(72) Inventor: SHINICHI TSUKAMURA, Uenohara-shi (JP)

(21) Appl. No.: 17/231,894

(22) Filed: Apr. 15, 2021

(30) Foreign Application Priority Data
Apr. 28, 2020 (JP) 2020-079331

(51) Int. Cl. G03G 21/16; G03G 15/20

(52) U.S. Cl. CPC G03G 21/1695; G03G 15/2014

(57) ABSTRACT

An image forming apparatus includes: an image forming part that forms an image on a recording medium; a fixing part that fixes the formed image on the recording medium; a reverse transport path that conveys to the image forming part the recording medium with a front and a back surface of the recording medium being reversed; a non-reverse transport path that conveys to the image forming part the recording medium without reversing the front and back surface of the recording medium; and a hardware processor that, when a second image is overlapped and formed on a first image by the image forming part on the front or back surface of the recording medium, performs control of switching whether the recording medium passes through the reverse transport path and the non-reverse transport path before the second image is formed after the first image is formed.

The entire disclosure of Japanese patent Application No. 2020-079331, filed on Apr. 28, 2020, is incorporated herein by reference in its entirety.

### BACKGROUND

### Technological Field

The present invention relates to an image forming apparatus.

### Description of the Related Art

In general, an image forming apparatus (printer, copier, facsimile, or the like) using an electrophotographic process technique forms an electrostatic latent image by irradiating (exposing) a laser beam based on image data on a charged photoconductor. Then, a toner is supplied from a developing device to the photoconductor (image carrier) on which the electrostatic latent image is formed, thereby visualizing the electrostatic latent image to form a toner image. Moreover, the toner image is directly or indirectly transferred to a recording medium (sheet) and thereafter fixed by heating and pressurizing in a fixing device, thereby forming an image on the sheet.

For the image forming apparatus, there is known a technique to form a background image on a recording medium (for example, colored sheet) and then form an upper layer image on the background image. In this technique, for example, a white background image (white image) is formed on a recording medium, and then an upper layer image (color image) of each color of YMCK is formed on the background image. Thus, color development of the color image can be improved and desired colors can be reproduced.

As a method of forming an upper layer image (color image) on a background image (white image), there is a method (1-pass method) such that an image forming unit that forms a background image (white image) is provided downstream of an image forming unit that forms an upper layer image (color image), and the background image and the upper layer image are once formed on an intermediate transfer body and then transferred to a recording medium at once.

Incidentally, as the toner adhesion amount accompanying formation of the background image (white image) is increased, color development of the upper layer image (color image) is improved, but the toner adhesion amount accompanying formation of the background image and the upper layer image increases. Thus, fixability of the background image and the upper layer image on the recording medium deteriorates and may cause poor fixation or the like.

Accordingly, there is a method (2-pass method) such that after a background image (white image) is formed and fixed on a recording medium, an upper layer image (color image) is formed and fixed on the background image, that is, forming and fixing the background image and the upper layer image on the recording medium are separated into two steps.

When the background image is formed on a front surface and a back surface (both sides) of the recording medium by the 2-pass method and then the upper layer image is formed on the background image, two image formations occur on one side, and hence four image formations in total occur on the both sides. In this case, from the viewpoint of improving productivity of image forming process, it is desirable to reduce the number of times of reversing operation of the recording medium for switching the image forming surface on the front and back surfaces as much as possible.

JP 2013-23330 A describes a technique for reducing the number of times of sheet reversing operation and suppressing an increase in the time required for sheet transportation, for example, when images are sequentially formed on both sides of one sheet.

However, when a background image is formed on the front and back surfaces of a recording medium by the 2-pass method and then an upper layer image is formed on the background image, if the number of times of reversing operation of the recording medium for switching the image forming surface on the front and back surfaces is set to one as in the technique described in JP 2013-23330 A, consecutive formation and fixing of the background image and the upper layer image on the same surface occur twice in total on each of the front and back surfaces. When the consecutive fixing processes occur on the same surface in this manner, wrinkles are likely to occur on the recording medium. Specifically when sheet deformation occurs in the first fixing process on the same surface of the recording medium, the sheet deformation is promoted by the second fixing process, and frequency of occurrence of wrinkles increases. Consequently, problems such as poor paper passage of the recording medium and deterioration of image quality due to paper wrinkles occur.

### SUMMARY

It is an object of the present invention to provide an image forming apparatus capable of improving productivity of an image forming process as much as possible while preventing occurrence of problems caused by consecutive fixing processes occurring on the same surface of a recording medium.

To achieve the abovementioned object, according to an aspect of the present invention, an image forming apparatus reflecting one aspect of the present invention comprises: an image forming part that forms an image on a recording medium; a fixing part that fixes the formed image on the recording medium;

a reverse transport path that conveys to the image forming part the recording medium with a front surface and a back surface of the recording medium on which the image is fixed being reversed;

a non-reverse transport path that conveys to the image forming part the recording medium without reversing the front surface and the back surface of the recording medium on which the image is fixed; and

a hardware processor that, when a second image is overlapped and formed on a first image by the image forming part on at least one of the front surface or the back surface of the recording medium, performs control of switching whether or not the recording medium passes through the reverse transport path and the non-reverse transport path before the second image is formed after the first image is formed, according to an image forming condition.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically illustrating an overall configuration of an image forming apparatus in a present embodiment;

FIG. 2 is a diagram illustrating a main part of a control system of the image forming apparatus in the present embodiment;

FIG. 3 is a diagram illustrating a relationship between a toner adhesion amount accompanying formation of a white image and fixable temperature;

FIG. 4 is a diagram illustrating an example of forming a white image on a front surface and a back surface (both sides) of a sheet and then forming a color image on the white image; and

FIG. 5 is a diagram illustrating an example of a control table according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

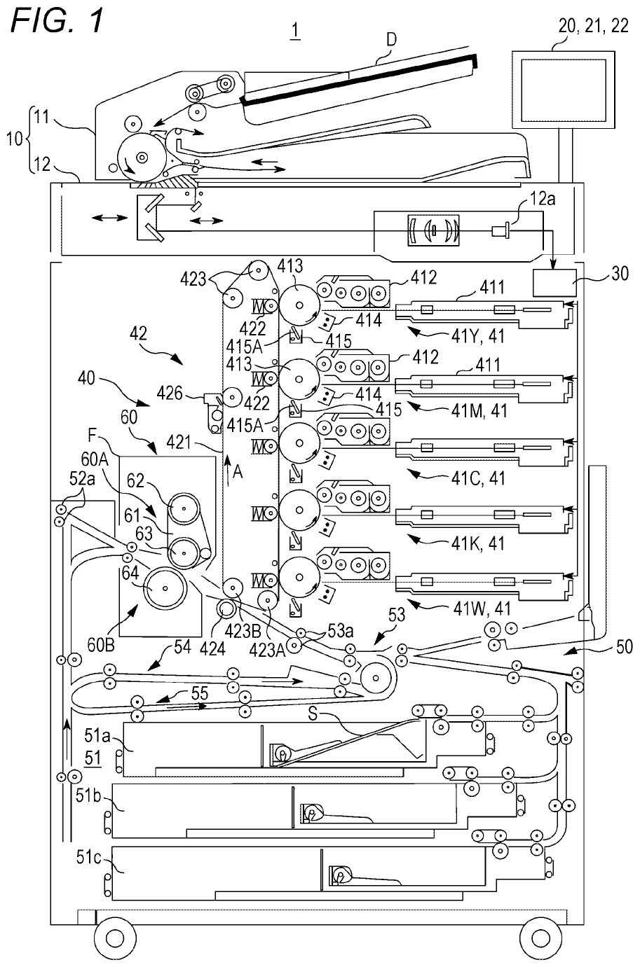

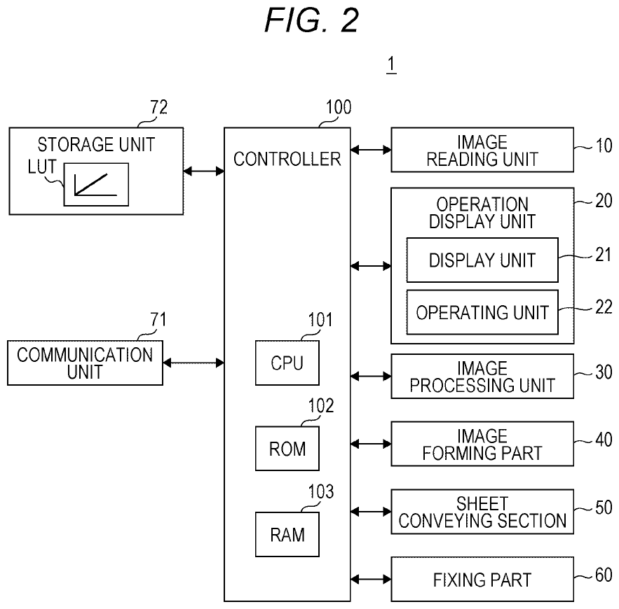

FIG. 1 is a view schematically illustrating an overall configuration of an image forming apparatus 1 in the present embodiment. FIG. 2 is a diagram illustrating a main part of a control system of the image forming apparatus 1 in the present embodiment.

As illustrated in FIGS. 1 and 2, the image forming apparatus 1 is an intermediate transfer type color image forming apparatus using an electrophotographic process technique. That is, the image forming apparatus 1 primarily transfers images of respective color toners of cyan (C), magenta (M), yellow (Y), black (K), and white (W) formed on a photoconductor to an intermediate transfer body, and thereafter secondary transfers them to a sheet (corresponding to a “recording medium” of the present invention), thereby forming an image.

Further, the image forming apparatus 1 employs a tandem method in which photoconductors corresponding to five colors of CMYKW are disposed in series in a traveling direction of the intermediate transfer body, and images of respective color toners are sequentially transferred to the intermediate transfer body.

In the present embodiment, the toners of four colors of Y (yellow), M (magenta), C (cyan), and K (black) (corresponding to a “second toner” of the present invention) are used as toners for forming a color image (corresponding to a “second image” of the present invention, which is also referred to as an upper layer image) based on input image data (input image information) on a sheet via the intermediate transfer body. On the other hand, the white toner of W (white) (corresponding to a “first toner” of the present invention) is used as a toner for forming a white image (corresponding to a “first image” of the present invention, which is also referred to as a background image) under the color image on the sheet from the viewpoint of improving color development of the color image and reproducing a desired color.

As illustrated in FIGS. 1 and 2, the image forming apparatus 1 includes an image reading unit 10, an operation display unit 20, an image processing unit 30, an image forming part 40, a sheet conveying section 50, a fixing part 60, and a controller 100.

The controller 100 includes a central processing unit (CPU) 101, a read only memory (ROM) 102, a random access memory (RAM) 103, and the like. The CPU 101 reads out a program corresponding to processing content from the ROM 102; expands the program in the RAM 103 (volatile memory), and centrally controls operation of each block of the image forming apparatus 1 in cooperation with the expanded program. At this time, various data such as a look up table (LUT) stored in a storage unit 72 are referred to.

The controller 100 transmits and receives various data to and from an external device (for example, a personal computer) connected to a communication network such as a local area network (LAN) or a wide area network (WAN) via a communication unit 71. The controller 100 receives, for example, input image data transmitted from the external device, and forms an image on a sheet based on the input image data. The communication unit 71 includes a communication control card such as a LAN card, for example.

The image reading unit 10 includes an automatic document feeding device 11 called an auto document feeder (ADF), a document image scanning device (scanner) 12, and so on.

The automatic document feeding device 11 conveys a document D placed on a document tray by a conveying mechanism and feeds the document D to the document image scanning device 12. By the automatic document feeding device 11, it is possible to consecutively read images (including both sides) of a large number of documents D placed on the document tray all at once.

The document image scanning device 12 optically scans a document D conveyed from the automatic document feeding device 11 onto a contact glass or a document D placed on the contact glass, allows reflected light from the document D to form an image on a light receiving surface of a charge coupled device (CCD) sensor 12a, and reads a document image. The image reading unit 10 generates input image data based on a reading result of the document image scanning device 12. The input image data is subjected to predetermined image processing in the image processing unit 30.

The operation display unit 20 includes, for example, a liquid crystal display (LCD) with a touch panel, and functions as a display unit 21 and an operating unit 22. The display unit 21 displays various operation screens, operation states of each function, and the like according to a display control signal input from the controller 100. The operating unit 22 includes various operation keys such as a numeric keypad and a start key, receives various input operations by a user, and outputs an operation signal to the controller 100.

The image processing unit 30 includes a circuit or the like that performs digital image processing on input image data according to initial settings or user settings. For example, the image processing unit 30 performs gradation correction under control of the controller 100 based on gradation correction data (gradation correction table). Further, the image processing unit 30 performs various correction processing such as color correction and shading correction, and compression processing and the like on the input image data, in addition to the gradation correction. The image forming part 40 is controlled based on the image data that has been subjected to these processes.

The image forming part 40 includes image forming units 41Y 41M, 41C, 41K (that function as a “second image forming part” in the present invention) for forming a color image with respective color toners of Y component, M component, C component, and K component based on the input image data, an image forming unit 41W (that functions as a “second image forming part” of the present invention) for forming a white image with a white toner of W component, and an intermediate transfer unit 42 or the like.

Note that when only a color image is formed, operation of the image forming unit 41W may be stopped from the viewpoint of improving durability of the image forming unit 41W. Further, when only a white image is formed, operation of the image forming units 41Y, 41M, 41C, 41K may be stopped from the viewpoint of improving durability of the image forming units 41Y, 41M, 41C, 41K.

The image forming units 41Y, 41M, 41C, 41K, 41W for the Y, M, C, K, and W components have similar configurations. For convenience of illustration and description, common components are denoted by the same reference numerals, and when they are distinguished from each other, reference numerals are appended with Y, M, CK, or W. In FIG. 1, reference signs are only given to components of the image forming unit 41Y for Y component, and reference signs are omitted for components of the other image forming units 41M, 41C, 41K, 41W.

The image forming unit 41 includes an exposure device 411, a developing device 412, a photoconductor drum 413, a charging device 414, a drum cleaning device 415, and the like.

The photoconductor drum 413 is, for example, a photoconductive photoconductor formed by sequentially stacking an undercoat layer (UCL), a charge generation layer (CGL), and a charge transport layer (CTL) on a peripheral surface of a conductive cylindrical body (aluminum tube) made of aluminum. The photoconductor drum 413 is, for example, an organic photo-conductor (OPC) of negatively charged type.

The charging device 414 uniformly charges a surface of the photoconductor drum 413 having photoconductivity to a negative electrode property. The charging device 414 is a scorotron charger.

The exposure device 411 includes, for example, a semiconductor laser and irradiates the photoconductor drum 413 with laser light corresponding to an image of each color component. When a positive charge is generated in the charge generation layer of the photoconductor drum 413 by irradiation with laser light and transported to a surface of the charge transport layer, a surface charge (negative charge) of the photoconductor drum 413 is neutralized. As a result, an electrostatic latent image of each color component is formed on the surface of the photoconductor drum 413 due to the potential difference from surroundings.

The developing device 412 contains a developer for each color component (for example, a two-component developer constituted of a toner having a small particle size and a carrier (magnetic material)), and causes the toner of each color component to adhere to the surface of the photoconductor drum 413, to thereby visualize an electrostatic latent image and form a toner image. A developing roller in the developing device 412 includes a cylindrical developing sleeve 412A that is driven to rotate, and a cylindrical magnet roller that is inserted in the developing sleeve 412A and fixed to a housing of the developing device 412 so as not to rotate.

The magnet roller is formed by arranging a plurality of magnets along a circumferential direction thereof, and a carrier is supported and conveyed on an outer peripheral surface of the developing sleeve 412A by the magnetic force thereof, and stands up at a developing position facing the photoconductor drum 413 to form a magnetic brush. At the developing position, a toner electrostatically attracted to the carrier and conveyed moves to the photoconductor drum 413 side due to the potential difference between the developing sleeve 412A and the photoconductor drum 413, and an electrostatic latent image formed on the peripheral surface thereof is developed.

The drum cleaning device 415 has a drum cleaning blade that is slidably contacted with the surface of the photoconductor drum 413. A transfer residual toner remaining on the surface of the photoconductor drum 413 after the primary transfer is scraped off and removed by the drum cleaning blade.

The intermediate transfer unit 42 includes an intermediate transfer belt 421, primary transfer rollers 422, a plurality of support rollers 423, a secondary transfer roller 424, a belt cleaning device 426, and the like.

The intermediate transfer belt 421 is formed by an endless belt, and is stretched in a loop around the plurality of support rollers 423. At least one of the plurality of support rollers 423 is formed by a driving roller, and the others are formed by driven rollers. For example, it is preferable that a roller 423A disposed downstream of the primary transfer roller 422 for the K component in a belt running direction is a driving roller. This makes it easier to keep a running speed of the belt in a primary transfer unit constant. Rotation of the driving roller 423A causes the intermediate transfer belt 421 to run in the direction of arrow A at a constant speed.

The intermediate transfer belt 421 is a belt having conductivity and elasticity, and has a high resistance layer on the surface. The intermediate transfer belt 421 is rotationally driven by a control signal from the controller 100.

A primary transfer roller 422 is disposed on an inner peripheral surface side of the intermediate transfer belt 421 so as to face the photoconductor drum 413 of each color component. The primary transfer roller 422 is pressed against the photoconductor drum 413 with the intermediate transfer belt 421 interposed therebetween, thereby forming a primary transfer nip for transferring a toner image from the photoconductor drum 413 to the intermediate transfer belt 421.

The secondary transfer roller 424 is disposed on the outer peripheral surface side of the intermediate transfer belt 421, opposing a backup roller 423B disposed downstream of the driving roller 423A in the belt running direction. The secondary transfer roller 424 is pressed against the backup roller 423B with the intermediate transfer belt 421 interposed therebetween, thereby forming a secondary transfer nip for transferring a toner image from the intermediate transfer belt 421 to the sheet S.

When the intermediate transfer belt 421 passes through the primary transfer nip, the toner images on the photoconductor drum 413 are sequentially overlapped and primary-transferred on the intermediate transfer belt 421. Specifically, a primary transfer bias is applied to the primary transfer roller 422 and a charge having a polarity opposite to that of the toner is given to a back side of the intermediate transfer belt 421, that is, a side in contact with the primary transfer roller 422, thereby electrostatically transferring the toner image to the intermediate transfer belt 421.

Thereafter, when the sheet S passes through the secondary transfer nip, the toner image on the intermediate transfer belt 421 is secondarily transferred to the sheet S. Specifically, a secondary transfer bias is applied to the secondary transfer roller 424 and a charge having a polarity opposite to that of the toner is given to a back surface side of the sheet S, that is, a side in contact with the secondary transfer roller 424, thereby electrostatically transferring the toner image to the sheet S. The sheet S to which the toner image has been transferred is conveyed toward the fixing part 60.

The belt cleaning device 426 removes a transfer residual toner remaining on the surface of the intermediate transfer belt 421 after the secondary transfer.

The fixing part 60 includes an upper fixing part 60A having a fixing surface side member disposed on the fixing surface of the sheet S, that is, the surface on which the toner image is formed, a lower fixing part 60B having a back surface side supporting member on the rear surface of the sheet S, that is, the surface opposite to the fixing surface, a heating source, and the like. When the back surface side supporting member is pressed against the fixing surface side member, a fixing nip for sandwiching and conveying the sheet S is formed.

The fixing part 60 heats and pressurizes the sheet S, to which the toner image has been secondarily transferred and which has been conveyed thereto, with the fixing nip, thereby fixing the toner image on the sheet S. The fixing part 60 is disposed as a unit in a fixing device F.

The upper fixing part 60A has an endless fixing belt 61 that is the fixing surface side member, a heating roller 62, and a fixing roller 63. The fixing belt 61 is stretched around the heating roller 62 and the fixing roller 63.

The fixing belt 61 comes into contact with the sheet S on which the toner image is formed, and heats the sheet S at a fixable temperature (for example, 160° C. to 200° C.). Here, the fixable temperature is a temperature at which the amount of heat required to melt the toner on the sheet S can be supplied, and varies depending on the paper type and basis weight of the sheet S on which an image is formed.

For the fixing belt 61, for example, polyimide (PI) having a thickness of 70 μm is used as a substrate, an outer peripheral surface of a substrate is covered with a heat-resistant silicone rubber having a thickness of 200 μm as an elastic layer, and a surface layer is coated with a perfluoroalkoxy (PFA), which is a heat-resistant resin.

The heating roller 62 has a built-in halogen heater as a heating source for heating the fixing belt 61 and thus the fixing roller 63.

In the fixing roller 63, for example, a solid core metal formed of a metal such as iron is covered with a heat-resistant silicone rubber (hardness JIS-A10°) having a thickness of 20 mm as an elastic layer on a surface layer, and further covered with a resin layer coated with PTFE, which is a low-friction, heat-resistant resin.

The lower fixing part 60B has a pressure roller 64 that is the back surface side supporting member. The pressure roller 64 pressurizes the fixing roller 63 with a predetermined fixing load (for example, 2200 N) via the fixing belt 61. In this manner, the pressure roller 64 forms the fixing nip that sandwiches and conveys the sheet S with the fixing roller 63 via the fixing belt 61.

When the sheet S passes through the fixing nip (during sheet passing), the pressure roller 64 presses against the silicon rubber (elastic layer) of the fixing roller 63 via the fixing belt 61 by a pressing means (not illustrated), and on the other hand, when the sheet S does not pass through the fixing nip (during non-sheet passing), the pressure roller 64 is separated from the silicon rubber of the fixing roller 63. Drive control of the pressure roller 64 (for example, on/off of rotation, rotation speed, or the like) is performed by the controller 100.

On the pressure roller 64, an outer peripheral surface of a cylindrical core metal formed by aluminum or the like is covered with a heat-resistant silicone rubber (hardness JIS-A10°) having a thickness of 3 mm as an elastic layer, and is further covered with a resin layer of a PFA tube. The pressure roller 64 has an outer diameter of, for example, 70 mm. The temperature of the pressure roller 64 is controlled to, for example, 80° C. to 120° C.

The sheet conveying section 50 includes a paper feed unit 51, a paper discharge unit 52, a conveying path 53, and so on. Sheets S (standard paper, special paper) identified based on basis weight, size, or the like are stored according to types set in advance in the three paper feed tray units 51a to 51c that constitute the paper feed unit 51.

The sheets S stored in the paper feed tray units 51a to 51c are sent out one by one from an uppermost part, and are conveyed to the image forming part 40 by a conveying mechanism provided with a plurality of conveying rollers such as a resist roller 53a. At this time, a resist unit on which the resist roller 53a is arranged corrects an inclination of the fed sheet S and adjusts transfer timing. Then, in the image forming part 40, the toner image on the intermediate transfer belt 421 is transferred onto one surface of the sheet S, and the fixing part 60 performs a fixing step. The sheet S on which the toner image is fixed by the fixing step is discharged to the outside of the image forming apparatus 1 by the paper discharge unit 52 including a paper discharge roller 52a.

Further, the sheet conveying section 50 includes a reverse transport path 54 and a non-reverse transport path 55. The reverse transport path 54 is a conveying path in which the front and back surfaces of the sheet S on which an image (toner image) is fixed by the fixing part 60 are reversed and conveyed to the image forming part 40. The non-reverse transport path 55 is a conveying path in which the sheet S on which the image (toner image) is fixed by the fixing part 60 is conveyed to the image forming part 40 without reversing the front and back surfaces.

As described above, in the image forming apparatus 1, a white image (background image) is formed on the sheet S (for example, colored sheet), and then a color image (upper layer image) of each color of YMCK is formed on the white image. Thus, color development of the color image can be improved and desired colors can be reproduced.

As a method of forming an upper layer image (color image) on the background image (white image), there is a 1-pass method such that the background image and the upper layer image are once formed on the intermediate transfer belt 421 and transferred to the sheet S at once.

Incidentally, as the toner adhesion amount accompanying formation of the background image (white image) is increased, color development of the upper layer image (color image) is improved, but the increased toner adhesion amount accompanying formation of the background image and the upper layer image may deteriorate fixability of the background image and the upper layer image on the sheet S and cause poor fixation or the like.

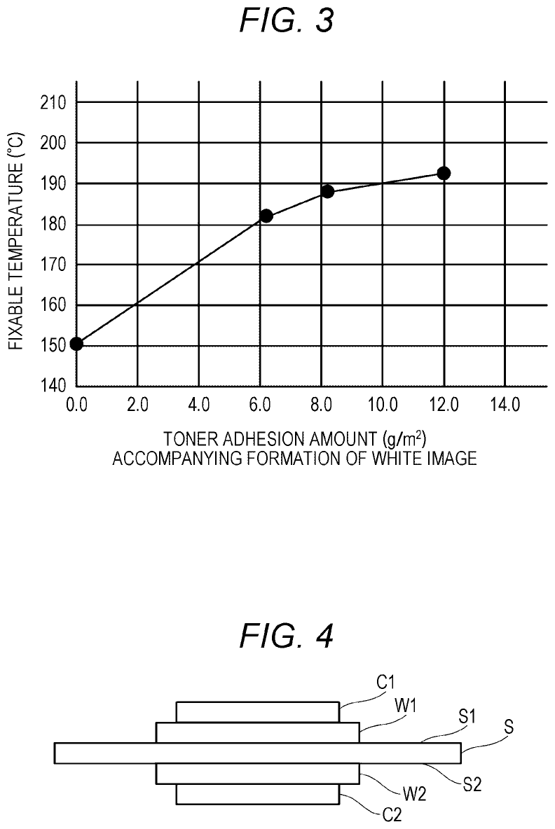

FIG. 3 is a diagram illustrating a relationship between the toner adhesion amount (horizontal axis) accompanying formation of a white image and the fixable temperature (vertical axis). As illustrated in FIG. 3, as the toner adhesion amount accompanying formation of the white image increases, the fixable temperature (the temperature at which the amount of heat required to melt the toner on the sheet S can be supplied) increases and fixability of the background image (white image) and the upper layer image (color image) deteriorates.

Accordingly, there is a 2-pass method such that after a background image (white image) is formed and fixed on the sheet S, the sheet S is passed through the non-reverse transport path 55 (conveyed to the image forming part 40 without reversing the front and back surfaces of the sheet S) and then an upper layer image (color image) is formed and fixed on the background image, that is, the background image and the upper layer image are formed and fixed on the sheet S in two steps.

As illustrated in FIG. 4, when background images W1, W2 are formed on a front surface S1 and a back surface S2 (both sides), respectively, of the sheet S by the 2-pass method, and then upper layer images C1, C2 are formed on the background images W1, W2, two image formations occur on one side, and hence four image formations in total occur on the both sides. In this case, from the viewpoint of improving productivity of the image forming process, that is, shortening the time related to the image forming process, it is desirable to reduce as much as possible the number of times of reversing operation of the sheet S for switching the image forming surface, on which the image is formed by the image forming part 40, on the front and back surfaces. For example, after the background image (white image) W1 is formed and fixed on the front surface S1 of the sheet S, the sheet S is passed through the non-reverse transport path 55, and then the upper layer image (color image) C1 is formed and fixed on the background image W1. Subsequently, after the sheet S is passed through the reverse transport path 54 and the background image (white image) W2 is formed and fixed on the back surface S2 of the sheet S, the sheet S is passed through the non-reverse transport path 55 and then the upper layer image (color image) C2 is formed and fixed on the background image W2. In this case, the number of times of reversing operation of the sheet S is one, which is most desirable from the viewpoint of improving productivity of the image forming process.

However, when the background images W1, W2 are formed on the front and back surfaces S1, S2 of the sheet S by the 2-pass method and then the upper layer images C1, C2 are formed on the background images W1, W2, if the number of times of reversing operation of the sheet S is one, consecutive formation and fixing of the background image (W1 or W2) and the upper layer image (C1 or C2) on the same surface (front surface S1 or back surface S2) occur twice in total on each of the front and back surfaces.

When the consecutive fixing process occurs on the same surface in this way, the sheet S is conveyed so as to pass through the image forming part 40 and the fixing part 60 without interchanging the front and rear ends of the sheet S, and thus wrinkles are likely to occur on the sheet S. Specifically, when paper deformation occurs in the first fixing process on the same surface of the sheet S, the paper deformation is promoted by the second fixing process, and the frequency of wrinkles increases. Consequently, problems such as poor paper passage of the sheet S and deterioration of image quality due to paper wrinkles occur.

Note that in general double-sided printing, consecutive fixing processes do not occur on the same side, and every time the fixing process is performed, the sheet is transported so that the front and back surfaces of the sheet S are reversed, that is, the front and rear ends of the sheet S are interchanged, and thus the above problem does not occur.

Furthermore, curling in the same direction may occur on the sheet S depending on the type of the sheet S and the configuration of the fixing part 60. In this case, if consecutive fixing processes occur on the same surface of the sheet S, a large curl occurs in the same direction, and paper jam is likely to occur on the sheet S being conveyed.

The above problem occurs more significantly when the sheet S is thin, that is, when the basis weight of the sheet S is small, than when the sheet S is thick, that is, when the basis weight of the sheet S is large. Further, the above problem occurs more significantly when the toner adhesion amount on the sheet S (also referred to as printing rate or coverage) is large than when the toner adhesion amount on the sheet S is small. Further, the above problem occurs more significantly when the size of the sheet S is large than when the size of the sheet S is small. Further, the above problem occurs more significantly when humidity around the image forming apparatus 1 is high than when the humidity around the image forming apparatus 1 is low. Further, the above problem occurs more significantly when the water content of the sheet S is high than when the water content of the sheet S is low. As described above, likelihood of the above problem differs depending on the difference in image forming conditions in the image forming apparatus 1.

Therefore, in the present embodiment, the image forming apparatus 1 capable of improving productivity of the image forming process while preventing occurrence of problems due to consecutive fixing processes occurring on the same surface of the sheet S is constructed. When the upper layer images (color images) C1, C2 are overlapped and formed on the background images (white images) W1, W2 by the image forming part 40 on the front surface S1 and the back surface S2 of the sheet S, the controller 100 performs control of switching whether or not the sheet S passes through the reverse transport path 54 and the non-reverse transport path 55 before the upper layer images C1, C2 are formed after the background images W1, W2 are formed, according to the image forming conditions.

For example, when the basis weight of the sheet S as an image forming condition is small, the above problem is more likely to occur than when the basis weight of the sheet S is large. Thus, when the basis weight of the sheet S is, for example, smaller than a predetermined value (for example, less than 90 g/m²), in order not to have consecutive fixing processes occurring on the same surface of the sheet S, the controller 100 controls so that, after the background image W1 is formed and fixed on the front surface S1 of the sheet S, the sheet S is passed through the reverse transport path 54 and then the background image W2 is formed and fixed on the back surface S2 of the sheet S. Next, after the sheet S is passed through the reverse transport path 54 and then the upper layer image C1 is formed and fixed on the background image W1 for the front surface S1 of the sheet S, the sheet S is passed through the reverse transport path 54, and then the upper layer image C2 is formed and fixed on the background image W2 for the back surface S2 of the sheet S. Such an image forming and fixing operation is hereinafter referred to as a first operation mode. When the first operation mode is executed, the number of times of reversing operation of the sheet S is three, which is not desirable from the viewpoint of improving the productivity of the image forming process, but it is possible to prevent occurrence of problems due to consecutive fixing processes occurring on the same surface of the sheet S.

On the other hand, when the basis weight of the sheet S is, for example, equal to or more than a predetermined value (for example, 90 g/m² or more), the controller 100 controls so that, after the background image W1 is formed and fixed on the front surface S1 of the sheet S, the sheet S is passed through the non-reverse transport path 55, and then the upper layer image C1 is formed and fixed on the background image W1 for the front surface S1 of the sheet S. Next, after the sheet S is passed through the reverse transport path 54 and then the background image W2 is formed and fixed on the back surface S2 of the sheet S, the sheet S is passed through the non-reverse transport path 55, and then the upper layer image C2 is formed and fixed on the background image W2 for the back surface S2 of the sheet S. Such an image forming and fixing operation is hereinafter referred to as a second operation mode. When the second operation mode is executed, the number of times of reversing operation of the sheet S is one, which is desirable from the viewpoint of improving the productivity of the image forming process, and problems due to consecutive fixing processes occurring on the same surface of the sheet S are unlikely to occur.

Further, in the present embodiment, considering that the fixability differs depending on the type of the sheet S, under image forming conditions with good fixability, the controller 100 controls so that, after the background image W1 and the upper layer image C1 are formed and fixed on the front surface S1 of the sheet S, the sheet S is passed through the reverse transport path 54, and then the background image W2 and the upper layer image C2 are formed and fixed on the back surface S2 of the sheet S. That is, the background image and the upper layer image are formed and fixed at once (1 pass) on the same surface of the sheet S. Such an image forming and fixing operation is hereinafter referred to as a third operation mode. When the third operation mode is executed, the number of times of image formation and fixing on one side is one, and also the number of times of reversing operation of the sheet S is one. Thus, the third operation mode is more desirable from the viewpoint of improving the productivity of the image forming process than the second operation mode in which the number of times of image formation and fixing on one side is two, and problems due to consecutive fixing processes occurring on the same surface of the sheet S are unlikely to occur.

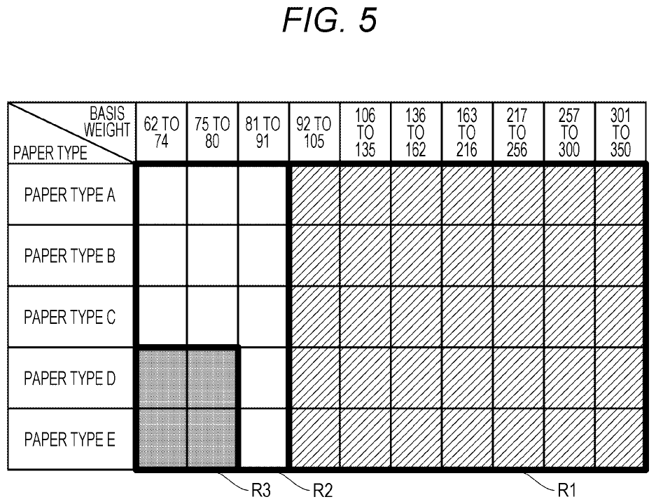

FIG. 5 illustrates an example of a control table to be used to determine the operation mode to be executed when the background image W1 and the upper layer image C1 are formed on the front surface S1 of the sheet S, and the background image W1 and the upper layer image C1 are formed on the back surface S2 of the sheet S.

As illustrated in FIG. 5, when an image forming condition indicated by an area R1 is satisfied (that is, when the paper type of the sheet S is any of paper types A to E, and the basis weight of the sheet S ranges from 92 g/m² to 350 g/m²), the controller 100 determines the second operation mode as the operation mode to be executed because a problem due to consecutive fixing processes occurring on the same surface of the sheet S does not occur, from the viewpoint of improving the productivity of the image forming process.

Further, when an image forming condition indicated by an area R2 is satisfied (that is, when the paper type of the sheet S is any of the paper types A to E, and the basis weight of the sheet S ranges from 62 g/m² to 91 g/m²), the controller 100 determines the first operation mode as the operation mode to be executed in order to prevent the occurrence of a problem due to consecutive fixing processes occurring on the same surface of the sheet S, even though it is not desirable from the viewpoint of improving the productivity of the image forming process.

Further, when an image forming condition indicated by an area R3 is satisfied (that is, when the paper type of the sheet S is any of the paper types D, E and the basis weight of the sheet S ranges from 62 g/m² to 80 g/m²), the controller 100 determines the third operation mode as the operation mode to be executed because the image forming condition is a condition with good fixability, from the viewpoint of further improving the productivity of the image forming process than in the second operation mode.

As described in detail above, in the present embodiment, the image forming apparatus 1 includes an image forming part 40 that forms an image on a sheet S (recording medium), a fixing part 60 that fixes the formed image on the sheet S, a reverse transport path 54 that conveys to the image forming part 40 the sheet S with a front surface and a back surface of the sheet S on which the image is fixed being reversed, a non-reverse transport path 55 that conveys to the image forming part 40 the sheet S without reversing the front and back surfaces of the sheet S on which the image is fixed, a controller 100 that, when an upper layer image C1, C2 (second image) is overlapped and formed on a background image W1, W2 (first image) by the image forming part 40 on the front and hack surfaces of the sheet S, performs control of switching whether or not the sheet S passes through the reverse transport path 54 and the non-reverse transport path 55 before the upper layer images C1, C2 are formed after the background image W1, W2 are formed, according to an image forming condition.

Specifically, when the basis weight of the sheet S is small, the controller 100 executes a first operation mode in which the background image W1 is formed on one (front surface S1) of the front and back surfaces, and the first image W2 is formed on the other (back surface S2) of the front and back surfaces after the sheet S passes through the reverse transport path 54, and when the basis weight of the sheet S is large, the controller 100 executes a second operation mode in which the background image W1 is formed on one (front surface S1) of the front and back surfaces, and the upper layer image C1 is formed on the one (front surface S1) of the front and back surfaces after the sheet S passes through the non-reverse transport path 55.

According to the present embodiment configured in this manlier, the operation mode to be executed is switched by focusing on that the likelihood of problems due to that consecutive fixing processes occurring on the same surface of the sheet S differs depending on a difference in image forming conditions (for example, the basis weight of the sheet S) in the image forming apparatus 1. That is, when the above problem is likely to occur, although it is not desirable from the viewpoint of improving the productivity of the image forming process, the first operation mode is executed so that the consecutive fixing processes do not occur on the same surface of the sheet S, and meanwhile, when the above problem is unlikely to occur, the second operation mode in which consecutive fixing processes occur on the same surface of the sheet S is executed from the viewpoint of improving the productivity of the image farming processing. Therefore, it is possible to improve the productivity of the image forming process as much as possible while preventing the occurrence of problems due to consecutive fixing process occurring on the same surface of the sheet S.

Note that in the above embodiment, an example of forming a white image as the background image by using white toner has been described, but the present invention is not limited to this. For example, a transparent toner (corresponding to a “first toner” of the present invention) may be used to form a white image (corresponding to a “first image” of the present invention) as the background image.

Further, in the above embodiment, an example of forming a color image as the upper layer image by using four color toners of Y, M, C, K has been described, but the present invention is not limited to this. For example, a toner of a specific color other than Y, M, C, K (corresponding to a “second toner” of the present invention) may be used to form a specific color image as the upper layer image (corresponding to a “second image” of the present invention).

Further, in the above-described embodiment, an example of executing the second operation mode when the basis weight of the sheet S is large has been described, but the present invention is not limited to this. For example, after forming and fixing the background image W1 on the front surface S1 of the sheet S, the sheet S is passed through the reverse transport path 54, and then the background image W2 is formed and fixed on the hack surface S2 of the sheet S. Next, after the sheet S is passed through the non-reverse transport path 55 and then the upper layer image C2 is formed and fixed on the background image W2 for the back surface S2 of the sheet S, the sheet S is passed through the reverse transport path 54, and then the upper layer image C1 is formed and fixed on the background image W1 for the front surface S1 of the sheet S. In this case, the number of times of reversing operation of the sheet S is two, which is desirable from the viewpoint of improving the productivity of the image forming process from the first operation mode, and problems due to consecutive fixing processes occurring on the same surface of the sheet S are less likely to occur than in the second operation mode.

Further, in the above embodiment, the case where the background images W1, W2 are formed on the front and back surfaces S1, S2 of the sheet S and then the upper layer images C1, C2 are formed on the background images W1, W2 has been described, but the present invention is not limited to this. For example, the present invention can be applied to a case where the background image is formed on one of the front and back surfaces of the sheet S and then the upper layer image is formed on the background image. In this case, when the basis weight of the sheet S is small, after the background image is formed and fixed on the front surface of the sheet S, the sheet S is passed through the reverse transport path 54 but the image is not formed and fixed on the back surface of the sheet S (empty paper passing), so that consecutive fixing processes do not occur on the same surface of the sheet S. Next, the sheet S is passed through the reverse transport path 54, and then the upper layer image is formed and fixed on the background image for the front surface S1 of the sheet S. On the other hand, when the basis weight of the sheet S is large, after the background image is formed and fixed on the front surface S1 of the sheet S, the sheet S is passed through the non-reverse transport path 55, and then an upper layer image is formed and fixed on the background image for the front surface S1 of the sheet S. Further, under an image forming condition with good fixability, the background image and the upper layer image may be formed on the front surface S1 of the sheet S, that is, the background image and the upper layer image may be formed on the same surface of the sheet S at once (1 pass).

Further, in the above-described embodiment, an example of determining the operation mode of the execution target by using a control table (see FIG. 5) that defines the paper type and basis weight of the sheet S has been described, but the present invention is not limited to this. For example, considering that fixability differs also depending on the toner adhesion amount on the sheet S, the operation mode to be executed may be determined using a control table that defines the toner adhesion amount on the sheet S and the basis weight. Here, the toner adhesion amount may be the maximum toner adhesion amount of the white image and the color image formed on the sheet S. Further, since the color image changes variously depending on the image pattern, it is difficult to determine the operation mode from information according to the change of the image pattern (toner adhesion amount) each time. Thus, the toner adhesion amount may be the amount of the adhered white image, which is usually not changed in one printing job. The toner adhesion amount of the white image may be determined by preference of the user, but may be changed depending on the color of the sheet S.

Further, in the above embodiment, a control table that defines not only the paper type, basis weight, and toner adhesion amount of the sheet S but also the image forming conditions such as the size of the sheet S, the water content, and the humidity around the image forming apparatus 1 may be used to determine the operation mode to be executed. Further, the contents of the control table defined for determining the operation mode to be executed may be arbitrarily changed according to an instruction of the user. That is, the controller 100 may control, according to an instruction of the user, switching of whether or not the sheet S passes through the reverse transport path 54 and the non-reverse transport path 55 before the upper layer images C1, C2 are formed after the background images W1, W2 are formed.

Although embodiments of the present invention have been described and illustrated in detail, the disclosed embodiments are made for purposes of illustration and example only and not limitation. The scope of the present invention should be interpreted by terms of the appended claims. That is, the present invention can be implemented in various forms without departing from the gist or main features thereof.

What is claimed is:

1. An image forming apparatus comprising:
an image forming part that forms an image on a recording medium;
a fixing part that fixes the formed image on the recording medium;
a reverse transport path that conveys to the image forming part the recording medium with a front surface and a back surface of the recording medium on which the image is fixed being reversed;
a non-reverse transport path that conveys to the image forming part the recording medium without reversing the front surface and the back surface of the recording medium on which the image is fixed; and
a hardware processor that, when a second image is overlapped and formed on a first image by the image forming part on at least one of the front surface or the back surface of the recording medium, performs control of switching whether or not the recording medium passes through the reverse transport path and the non-reverse transport path before the second image is formed after the first image is formed, according to an image forming condition.

2. The image forming apparatus according to claim 1, wherein when the second image is overlapped and formed on the first image by the image forming part on the front surface and the back surface of the recording medium, the hardware processor switches, according to the image forming condition, whether to form the first image on one of the front surface and the back surface, pass the recording medium through the reverse transport path, and thereafter form the first image on the other of the front surface and the back surface, or to form the first image on one of the front surface and the back surface, pass the recording medium through the non-reverse transport path, and thereafter form the second image on the one of the front surface and the back surface.

3. The image forming apparatus according to claim 2, wherein when a basis weight of the recording medium is smaller than a predetermined value, the hardware processor performs control to form the first image on one of the front surface and the back surface, pass the recording medium through the reverse transport path, and thereafter form the first image on the other of the front surface and the back surface, or when the basis weight of the recording medium is equal to or larger than the predetermined value, the hardware processor performs control to form the first image on one of the front surface and the back surface, pass the recording medium through the non-reverse transport path, and thereafter form the second image on the one of the front surface and the back surface.

4. The image forming apparatus according to claim 1, wherein according to the image forming condition, the hardware processor performs control so that the second image is overlapped and formed on the first image without the recording medium passing through the reverse transport path and the non-reverse transport path, on one of the front surface and the back surface of the recording medium.

5. The image forming apparatus according to claim 1, wherein the image forming part has:
a first image forming part that forms the first image using a first toner; and
a second image forming part that forms the second image using a second toner different from the first toner.

6. The image forming apparatus according to claim 1, wherein the image forming condition is a toner adhesion amount on the recording medium.

7. The image forming apparatus according to claim 1, wherein the image forming condition is a basis weight of the recording medium.

8. The image forming apparatus according to claim 1, wherein the image forming condition is a size of the recording medium.

9. The image forming apparatus according to claim 1, wherein the image forming condition is humidity around the image forming apparatus.

10. The image forming apparatus according to claim 1, wherein the image forming condition is a water content of the recording medium.

11. The image forming apparatus according to claim 1, wherein the image forming condition is a paper type of the recording medium.

12. The image forming apparatus according to claim 1, wherein the hardware processor performs control of switching whether or not the recording medium passes through the reverse transport path and the non-reverse transport path according to an instruction of a user.
